(19) United States
(12) Patent Application Publication
(10) Pub. No.: US 2006/0100345 A1
(43) Pub. Date: May 11, 2006

(54) Synthetic gravel

(76) Inventors: Wyatt Bain, Kenosha, WI (US); Michael J. Bain, Kenosha, WI (US)

Correspondence Address: JANSSON, SHUPE, MUNGER & ANTARAMIAN, LTD, 245 MAIN STREET, RACINE, WI, 53403, US

(21) Appl. No.: 10/975,610

(22) Filed: Oct. 28, 2004

(51) Int. Cl. C08K 3/40

(52) U.S. Cl. 524/494

(57) ABSTRACT

Lightweight synthetic gravel is comprised of glass particles made from recycled glass and plastic particles made from recycled plastic is formed by mixing the glass and plastic particles and heating the plastic particles to a softened state to allow the glass and plastic particles to be pressed into and retain a desired form. The method of producing the gravel includes grading glass into glass particles, grading plastic into plastic particles, mixing the glass particles and the plastic particles, heating the plastic particles such that the plastic particles soften and become moldable, molding the heated mixture of glass and plastic particles into a desired form, and allowing the desired form to harden.

### FIELD OF THE INVENTION

The invention relates generally to the production of synthetic gravel, and, more particularly, to such production utilizing recycled materials.

### BACKGROUND OF THE INVENTION

Rock materials utilized in construction generally are in the forms of flagstones and granules. The former is used as a finishing material and usually as an external surface for flooring installations, while the latter, depending on its grain size and specific gravity (strength), is usually used as a grading or concrete aggregate. The source of the granules is mostly gravel from riverbeds. The inherited weight of such granules when used in the site foundation or the structure of a building with a low number of floors is directly borne by the earth bed, and has minimal impact upon the overall structure or cost. However, the weight and cost of rock materials can become a major problem when constructing high-rise buildings.

Rock materials are also harvested from quarries. Such quarries often impose environmental risks on the surrounding areas and often waste land which could be better used in other ways. Moreover, quarries are frequently a great distance from the site at which gravel is needed. This requires that heavy gravel be trucked great distances.

Weight of construction materials is typically a very critical element in the design of buildings. For instance, a wall panel to be used as a external curtain wall or a partition usually requires a light-weight and sufficient strength of the composite construction. The required weight and strength of the desired rock material leads to complicated preparation, higher cost and significant waste material due to mass pre-casting of units followed by a cutting operation, resulting in problems in subsequent processes.

Furthermore, there are many articles formed from concrete which suffer from excessive weight. For instance, a planter for a small tree or shrub constructed from typical concrete is often too heavy for the owner to move once it has been delivered to the owner and positioned. Likewise, patio furniture, light poles, fountains, and other concrete articles are frequently left in their original position due to the difficulty encountered when attempting to move them. Therefore, a method of producing less dense, but structurally sound, concrete would be an important improvement in the field.

Rock materials have been comprehensively applied in foundation grading in the construction industry. In large-scale construction projects such as highways, parking lots and buildings having extremely large footprints, the costs of the rock material become extremely significant. Therefore, a method which reduces the material costs involved in foundation grading would be of great benefit for large-scale construction projects.

Loose gravel is also used in smaller-scale projects. It may be provided as a pathway, driveway, roadway, or, particularly in arid areas, it may be used as a substitute for a lawn or garden. When used in visible areas such as driveways, lawns, and gardens, the gravel may be formed from distinct rock materials which provide aesthetic appeal. Such materials are typically very expensive.

Loose gravel is also used as a roofing material. Gravel provides many benefits in roofing projects, including protecting the roof from the sun's rays, protection the roof from foot traffic, proving weight as additional protection for wind uplift, and reducing the surface temperature of the roof. Of course, weight is an important consideration when working with roofing. It would be a great improvement in roofing to reduce weight on the roof while providing the desired benefits of gravel use.

Loose gravel is also used to provide for drainage. Porous natural gravels such as crushed limestone breakdown over time due to efflorescence when used in areas with salt-laced ground water. When the gravel breaks down it becomes compacted and ends up restricting the flow of water—hindering its very purpose. Efflorescence also impacts the use of porous gravels in concrete. When a natural gravel in concrete has absorbed water, temperature changes leading to freezing and thawing can cause the concrete to crack. Such cracking can cause great structural damage over time.

An easily overlooked benefit to the reduction of weight of structurally sound gravel is the reduction of strain on delivery vehicles, the reduction of strain on roadways, and an increase in efficiency in delivering gravel (since a vehicle may carry a larger amount of lighter gravel compared to typical gravel). As noted above, this benefit is magnified by the current practice of trucking dense gravel across great distances to construction sites.

In addition to the problems associated with the current state of gravel use, there is a growing problem with plastic waste. Most families in the developed world throw away about 90 lbs. of plastic a year. These plastics can take up to 400 years to break down in a landfill. With the public's sensible desire to minimize the size of landfills, there is a strong movement to recycle as much plastic as possible. In addition to reducing the amount of landfill areas, recycling plastic saves twice as much energy as burning it in an incinerator. Furthermore, studies have shown that while incinerating 10,000 tons of waste creates 1 job and landfilling the same amount creates 6 jobs, recycling the same 10,000 tons creates 36 jobs.

Therefore, providing an additional use for recycled plastic would facilitate environmental goals. Moreover, providing such a use near areas where large amounts of plastics are disposed of also minimizes trucking and the associated roadway wear and tear, traffic, pollution, and gasoline use.

A method for forming improved gravel which addresses the problems of the prior art would be an important advance in the art. The present invention is directed to such a method and the resulting gravel which overcomes the disadvantages of the prior art.

### OBJECTS OF THE INVENTION

It is therefore an object of the present invention to provide a method of using recycled glass and plastic to form synthetic gravel.

Another object of the present invention is to provide synthetic gravel which is non-porous.

Another object of the present invention is to provide synthetic gravel which is not affected by efflorescence.

Another object of the present invention is to provide synthetic gravel which is lightweight.

A further object of the present invention is to reduce the amount of glass and plastic disposed of.

Yet another object of the present invention is to reduce the weight of gravel used in roofing.

Yet another object of the present invention is to allow the manufacture of a specific weight gravel for a specific desired use.

Yet another object of the present invention is to provide a method of increasing the amount of gravel which can be transported by a standard truck.

How these and other objects are accomplished will become apparent from the following descriptions and the drawings.

### SUMMARY OF THE INVENTION

This invention is a synthetic gravel and methods of production and use of the gravel. The invention represents a significant advance over the state of the art by providing an improved gravel and related methods.

In an embodiment of the invention, the method of producing synthetic gravel comprises grading glass into glass particles; grading plastic into plastic particles; mixing the glass particles and the plastic particles; heating the plastic particles such that the plastic particles soften and become moldable; molding the heated mixture of glass and plastic particles into a desired form; and allowing the molded desired form to harden.

In certain embodiments of the method, the ratio of plastic to glass is about 2:1 by weight. In other embodiments, the ratio of plastic to glass is about 1:1 by weight. In other embodiments, the ratio of plastic to glass is about 1:3 by weight. A certain preferred range of the plastic to glass ratio include 0.33:1 to 3:1 or higher. The plastic to glass ratio may be altered according to the desired final use of the gravel.

In certain embodiments of the method, the synthetic gravel has a density of about 749.66 kg/m³. In other embodiments, the synthetic gravel has a density of about 700 kg/m³, sometimes more preferably about 650 kg/m³, and sometimes more preferably about 600 kg/m³. Certain preferred ranges of the gravel density are between about 300-800 kg/m³, between about 400-750 kg/m³, and between about 600-750 kg/m³.

In certain embodiments of the method, the plastic particles are heated to about 124-165° C. Such heating preferably allows the plastic to soften and be moldable about the glass particles. In certain embodiments, the plastic particles are heated after being mixed with the glass particles. In certain embodiments, the plastic particles have a diameter of less than about ¼ inch. The plastic particles may be washed before mixing, though certain contaminants are removed during heating. In certain embodiments, the glass particles are sand-like, i.e., the glass particles have a dimension similar to that of sand—roughly less than ⅛ inch in diameter.

The method may involve separately preparing the plastic and glass particles. The plastic particles may be prepared by collecting recycled plastic bottles, containers or other goods; crushing such plastic goods so that they are substantially flat; filtering the goods with a magnet, preferably an electromagnet, to remove any metallic debris; and grinding or cutting the plastic goods into small plastic particles which are less than about ¾ inch, or ½ inch in diameter. Most preferably, the plastic particles are less than about ¼ inch in diameter.

In certain embodiments, glass particles are prepared from recycled glass products. Such glass products are collected and broken into coarse pieces, preferably through use of a first grading mechanism. The coarse pieces are then filtered with a magnet, preferably an electromagnet, to remove any metallic debris and are passed through a screen to remove any paper or labels from the glass particles. The filtered glass particles are then passed through a second grading mechanism which reduces the particles to a fine, sand-like dimension.

After such preparation, streams of the plastic and glass particles may be mixed together while being heated, preferably to between about 124°-165° C. Such temperature may be dependent on the source of the plastic particles, i.e., certain plastics may require less heat than others to achieve softening. Some preferred plastics include thermoplastic materials like polyethylenes and polypropylenes. The plastic and glass are mixed together until the glass particles are cohered and/or covered by melted plastic and form a pourable mixture which is poured into a molding mechanism having cavities of sizes and shapes desired for the synthetic gravel. The molding mechanism may form gravel of a standard size such as a round shape with a diameter of about 1 inch or 1½ inches, or to a variety of shapes and sizes such that the gravel includes many different-shaped and -sized gravel pieces. The synthetic gravel can be molded to match the size and shape of any typical gravel, which may be preferred if the synthetic gravel is added to typical gravel which is already in use.

In an embodiment of the invention, lightweight synthetic gravel comprised of glass particles made from recycled glass and plastic particles made from recycled plastic is formed by mixing the glass and plastic particles and heating the plastic particles to a softened state to allow the glass and plastic particles to be pressed into and retain a desired form.

In certain embodiments of the lightweight synthetic gravel, the ratio of plastic to glass is about 2:1 by weight. In other embodiments, the ratio of plastic to glass is about 1:1 by weight. In other embodiments, the ratio of plastic to glass is about 1:3 by weight. A certain preferred range of the plastic to glass ratio include 0.33:1 to 3:1 or higher.

In certain embodiments of the lightweight synthetic gravel, the gravel has a density of about 749.66 kg/m³. In other embodiments, the synthetic gravel has a density of about 700 kg/m³, sometimes more preferably about 650 kg/m³, and sometimes more preferably about 600 kg/m³. Certain preferred ranges of the gravel density are between about 300-800 kg/m³, between about 400-750 kg/m³, and between about 600-750 kg/m³.

In certain embodiments of the lightweight gravel, the plastic particles have a diameter of less than about ¼ inch. In certain embodiments, the glass particles are sand-like, i.e., the glass particles have a dimension similar to that of sand—roughly less than ⅛ inch in diameter.

In certain embodiments of the invention, the non-porous synthetic gravel consisting of glass particles made from recycled glass and plastic particles made from recycled plastic is formed by mixing the glass and plastic particles and heating the plastic particles to a softened state to allow that glass and plastic particles to be pressed into and retain a desired form.

In certain embodiments of the non-porous synthetic gravel, the ratio of plastic to glass is about 2:1 by weight. In other embodiments, the ratio of plastic to glass is about 1:1 by weight. In other embodiments, the ratio of plastic to glass is about 1:3 by weight. A certain preferred range of the plastic to glass ratio include 0.33:1 to 3:1 or higher.

In certain embodiments of the non-porous synthetic gravel, the gravel has a density of about 749.66 kg/m³. In other embodiments, the synthetic gravel has a density of about 700 kg/m³, sometimes more preferably about 650 kg/m³, and sometimes more preferably about 600 kg/m³. Certain preferred ranges of the gravel density are between about 300-800 kg/m³, between about 400-750 kg/m³, and between about 600-750 kg/m³.

### BRIEF DESCRIPTION OF THE DRAWINGS

FIG. 1 is a perspective view of the two desired forms of synthetic gravel in accordance with an embodiment of the invention.

FIG. 2 is a flow chart demonstrating the method in accordance with an embodiment of the invention.

FIG. 3 is a plan view of the apparatus for performing the method in accordance with an embodiment of the invention.

### DETAILED DESCRIPTION OF PREFERRED EMBODIMENTS

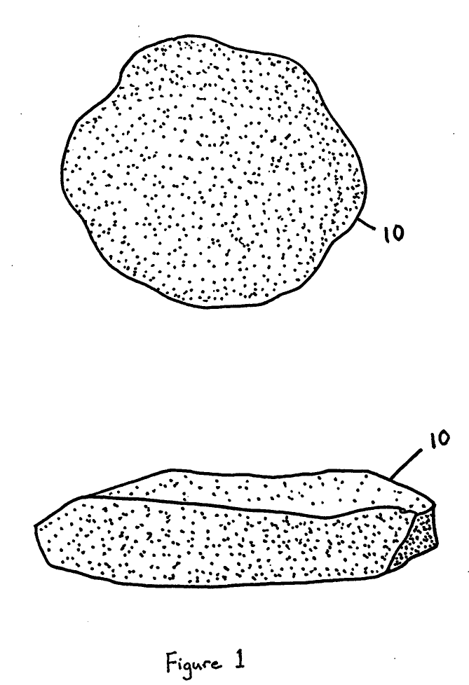

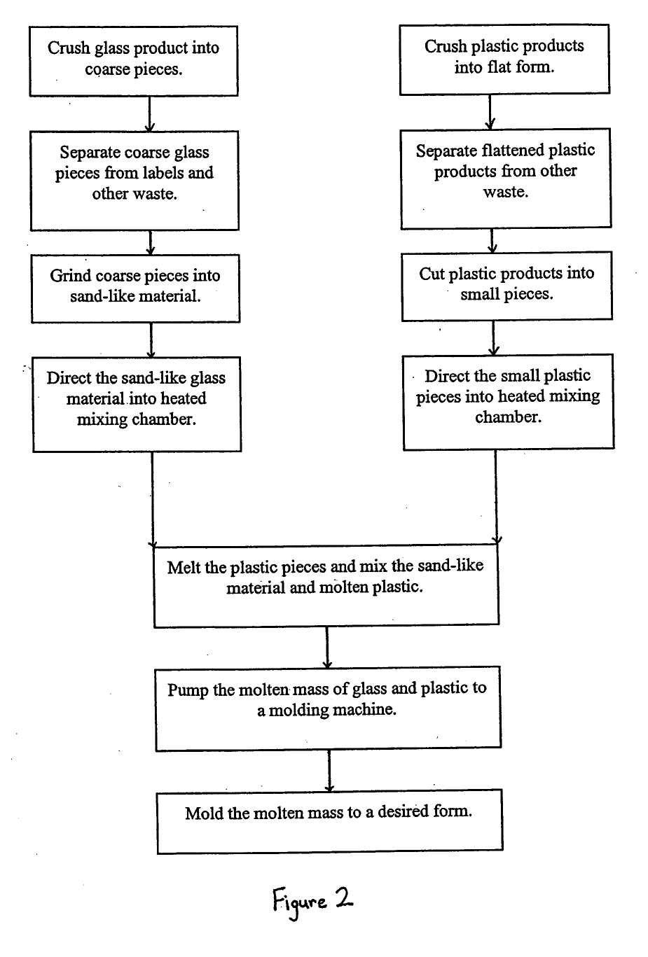

FIG. 1 is a perspective view of two desired forms 10 of synthetic gravel. FIG. 2 demonstrates a method of preparing such gravel from glass and plastic products. As shown in the left stream, glass products are provided and are crushed into coarse pieces. The coarse glass pieces are then separated from labels and other waste. Then the coarse glass pieces are grinded into sand-like material. The sand-like material is then directed into a heated mixing chamber.

As shown in the right stream, plastic products are provide and are crushed flat. The flattened plastic products are then separated from other waste before they are cut into small pieces. The small plastic pieces are directed into the heated mixing chamber.

At that time the sand-like glass material and small plastic pieces are mixed together. The heat is sufficient to melt the plastic pieces to form a molten mass of glass and plastic. The molten mass is then pumped to a molding machine which molds the mass into a desired form.

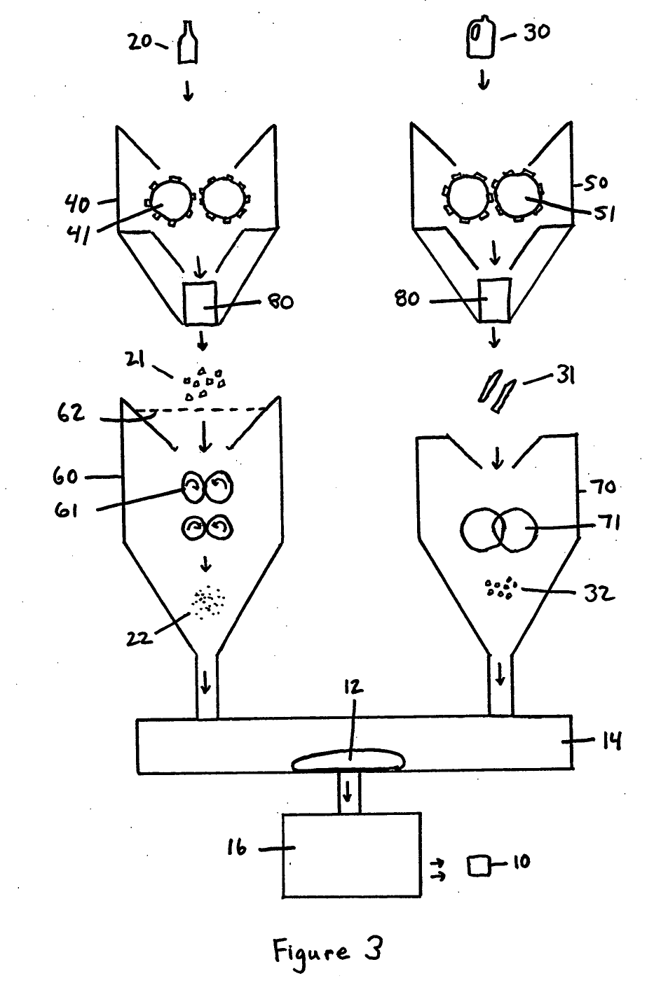

FIG. 3 depicts an embodiment of a device for performing the method as outlined in FIG. 2. Recycled glass 20 is fed into a first glass crushing device 40 which may incorporated crushing wheels 41 to crush the glass into coarse pieces 21. The coarse pieces 21 pass by or through an electromagnet 80 which removes metal objects from the glass stream. The coarse pieces 21 then must pass through a screen 62 which stops large pieces and foreign material from passing into second glass crusher 60. Second glass crusher 60 may include two pairs of crushing wheels 61 which crush or pulverize coarse pieces 21 into a sand-like material 22. Sand-like material 22 is then fed into heated mixing machine 14.

Recycled plastic 30 is fed into a first plastic crushing device 50 which may incorporated crushing wheels 51 to flatten the plastic products 30 flat. The flattened plastic products 31 pass by or through an electromagnet 80 which removes metal objects from the plastic stream. The flattened plastic products 31 are then directed into a plastic shredder 70. Plastic shredder 70 may include a pair of shredding wheels 71 which shred or cut the flattened plastic into small plastic pieces 32. Small plastic pieces 32 are then fed into heated mixing machine 14.

Heated mixing machine 14 melts plastic pieces 32 and mixes the glass and plastic together to form a heated mixture 12. Heated mixing machine 14 also burns off foreign material which may still be in the streams. Heated mixing machine preferably reaches a temperature of about 124-165° C. to form heated mixture 12. Heated mixture 12 forms a thermoplastic slurry and is pumped to molding machine 16 which molds heated mixture 12 into desired forms 10. Desired forms 10 could be any size or shape as is needed for their intended use.

Thus, it should be apparent that there has been provided, in accordance with the present invention, a synthetic gravel and method of forming such synthetic gravel that fully satisfies the objectives and advantages set forth above.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method of producing synthetic gravel, the method comprising:
grading glass into glass particles;
grading plastic into plastic particles;
mixing the glass particles and the plastic particles;
heating the plastic particles such that the plastic particles soften and become moldable;
molding the heated mixture of glass and plastic particles into a desired form; and
allowing the desired form to harden.

2. The method of claim 1 wherein the ratio of plastic to glass is about 2:1 by weight.

3. The method of claim 1 wherein the ratio of plastic to glass is about 1:1 by weight.

4. The method of claim 1 wherein the ratio of plastic to glass is about 1:3 by weight.

5. The method of claim 1 wherein the synthetic gravel has a density of about 749.66 kg/m³.

6. The method of claim 1 wherein the plastic particles are heated to about 124-165° C.

7. The method of claim 1 wherein the plastic particles are heated after being mixed with the glass particles.

8. The method of claim 1 wherein the glass particles are sand-like.

9. The method of claim 1 wherein the plastic particles have a diameter of less than about ¼ inch.

10. The method of claim 1 wherein the plastic particles are washed before mixing.

11. Lightweight synthetic gravel comprised of glass particles made from recycled glass and plastic particles made from recycled plastic, the gravel being formed by mixing the glass and plastic particles and heating the plastic particles to a softened state to allow the glass and plastic particles to be pressed into and retain a desired form.

12. The lightweight synthetic gravel of claim 11 wherein the ratio of plastic particles to glass particles is 2:1 by weight.

13. The lightweight synthetic gravel of claim 11 wherein the ratio of plastic particles to glass particles is 1:1 by weight.

14. The lightweight synthetic gravel of claim 11 wherein the ratio of plastic particles to glass particles is 1:3 by weight.

15. The lightweight synthetic gravel of claim 11 wherein the gravel has a density of about 749.66 kg/m³.

16. The lightweight synthetic gravel of claim 11 wherein the glass particles are sand-like.

17. The lightweight synthetic gravel of claim 11 wherein the plastic particles have a dimension of less than about ¼ inch.

18. Non-porous synthetic gravel consisting of glass particles made from recycled glass and plastic particles made from recycled plastic, the gravel being formed by mixing the glass and plastic particles and heating the plastic particles to a softened state to allow that glass and plastic particles to be pressed into and retain a desired form.

19. The non-porous synthetic gravel of claim 18 wherein the ratio of plastic particles to glass particles is 2:1 by weight.

20. The non-porous synthetic gravel of claim 18 wherein the gravel has a density of about 749.66 kg/m³.
